(19) United States
(12) Patent Application Publication
(10) Pub. No.: US 2020/0094781 A1
(43) Pub. Date: Mar. 26, 2020

(54) ELECTROMAGNETIC WAVE UTILIZING SYSTEM

(71) Applicant: DENSO CORPORATION, Kariya-city (JP)

(72) Inventors: Koji OTA, Kariya-city (JP); Yoshiyuki YOKOYAMA, Kariya-city (JP); Shinichiro NAKAMURA, Kariya-city (JP); Kotaro FUKUDA, Kariya-city (JP)

(21) Appl. No.: 16/692,889

(22) Filed: Nov. 22, 2019

Related U.S. Application Data
(63) Continuation of application No. PCT/JP2018/021118, filed on Jun. 1, 2018.

(30) Foreign Application Priority Data
Jun. 13, 2017 (JP) 2017-116049
Feb. 14, 2018 (JP) 2018-023783
Apr. 5, 2018 (JP) 2018-073015

(51) Int. Cl. B60S 1/02; B60S 1/60

(52) U.S. Cl. CPC B60S 1/026; B60S 1/60

(57) ABSTRACT

An electromagnetic wave utilizing system includes an electromagnetic wave apparatus configured to perform transmitting and/or receiving of an electromagnetic wave, and a heater that heats a passage member. The heater includes a heating element and a holder. The heating element and the holder are transparent to allow the electromagnetic wave to transmit therethrough. The electromagnetic wave apparatus transmits and/or receives the electromagnetic wave while rotating on a horizontal plane. The heater is configured to rotate together with the electromagnetic wave apparatus or to surround the electromagnetic wave apparatus 360 degrees in a horizontal direction.

### CROSS REFERENCE TO RELATED APPLICATION

This application is a continuation application of international Patent Application No. PCT/JP2018/021118 filed on Jun. 1, 2018, which designated the U.S. and claims the benefits of priority from Japanese Patent Application No. 2017-116049 filed on Jun. 13, 2017, Japanese Patent Application No. 2018-023783 filed on Feb. 14, 2018, and Japanese Patent Application No. 2018-073015 filed on Apr. 5, 2018. The entire of disclosure of all of the above applications are incorporated herein by reference.

### TECHNICAL FIELD

The present disclosure relates to an electromagnetic wave utilizing system that utilizes an electromagnetic wave.

### BACKGROUND ART

A camera mounted in a vehicle to capture a scene of a rear field of view of the vehicle has been known. The camera for the vehicle is mounted at a ceiling in a vehicle cabin and located adjacent to a rear window. The camera captures a scene outside the vehicle through the rear window.

The camera is located so that a heater wire of a defogger for the rear window is not located within a field of view of the camera. The defogger is a device to remove a fog of the rear window by heating the rear window with the heater wire.

### SUMMARY OF INVENTION

According to an aspect of the present disclosure, an electromagnetic wave utilizing system includes an electromagnetic wave apparatus and a heater. The electromagnetic wave apparatus performs at least one of transmitting and receiving of the electromagnetic wave. The heater heats a passage member through which the electromagnetic wave passes. The heater includes a heating element to generate a heat when energized and a holder to hold the heating element. The heating element and the holder are transparent to allow the electromagnetic wave to transmit therethrough. The electromagnetic wave apparatus transmits and/or receives an electromagnetic wave while rotating on a horizontal plane. The heater is configured to rotate together with the electromagnetic wave apparatus, or to surround the electromagnetic wave apparatus 360 degrees in a horizontal direction.

### BRIEF DESCRIPTION OF DRAWINGS

The above and other objects, features and advantages of the present disclosure will become more apparent from the following detailed description made with reference to the accompanying drawings.

FIG. 1 is a cross sectional view of an image capturing system for a vehicle in accordance with a first embodiment.

FIG. 2 is a partially enlarged cross sectional view illustrating the image capturing system for the vehicle in FIG. 1.

FIG. 3 is a plane view of a heater of the image capturing system.

FIG. 4 is a flow chart for a control process performed by a controlling device in the image capturing system for the vehicle in the first embodiment.

FIG. 5 is a cross sectional view of a laser system in accordance with a second embodiment.

FIG. 6 is a plane view when viewed along an arrow VI in FIG. 5.

### DESCRIPTION OF EMBODIMENTS

To begin with, examples of relevant techniques will be described.

A camera mounted in a vehicle to capture a scene of a rear field of view of the vehicle has been known. Such a camera for the vehicle may be mounted at a ceiling in a vehicle cabin and located adjacent to a rear window. The camera captures a scene outside the vehicle through the rear window.

The camera is located so that a heater wire of a defogger for the rear window is not located within a field of view of the camera. The defogger is a device to remove a fog of the rear window by heating the rear window with the heater wire.

The camera for the vehicle is mounted so that the heater wire of the defogger for the rear window is not located within the field of view of the camera. Thus, the heater wire of the defogger does not interfere with the field of view of the camera.

On the other hand, the heater wire is not located within the field of view of the camera, and therefore a fog of the rear window in such an area cannot be removed clearly. The visibility for the camera may not be secured sufficiently when the rear window fogs up.

This issue may also happen in various electromagnetic wave utilizing systems that utilizes an electromagnetic wave such as a laser apparatus for a vehicle that transmits and receives a laser other than a camera mounted in a vehicle that captures a visible light.

In the present disclosure, an electromagnetic wave utilizing system to heat a passage member through which an electromagnetic wave passes without interfering with travel of the electromagnetic wave is provided.

According to an aspect of the present disclosure, an electromagnetic wave utilizing system includes an electromagnetic wave apparatus and a heater. The electromagnetic wave apparatus performs at least one of transmitting and receiving of the electromagnetic wave. The heater heats a passage member through which the electromagnetic wave passes. The heater includes a heating element to generate a heat when energized and a holder to hold the heating element. The heating element and the holder are transparent to allow the electromagnetic wave to transmit therethrough. The electromagnetic wave apparatus transmits and/or receives an electromagnetic wave while rotating on a horizontal plane. The heater is configured to rotate together with the electromagnetic wave apparatus, or to surround the electromagnetic wave apparatus 360 degrees in a horizontal direction.

Therefore, the electromagnetic wave utilizing system can heat the passage member without interfering with travel of the electromagnetic wave.

Hereinafter, embodiments will be described according to the drawings. Same or equivalent portions among respective embodiments below are labeled with same reference numerals in the drawings.

### First Embodiment

Hereinafter, an image capturing system for a vehicle in the first embodiment will be described with reference to the drawings. Arrows indicating an up side, a down side, a front side, and a rear side in figures show an upward direction, a downward direction, a forward direction, and a rearward direction of the vehicle respectively. The image capturing system including a camera 100 for a vehicle is an electromagnetic wave utilizing system that utilizes a visible light that is one type of electromagnetic waves.

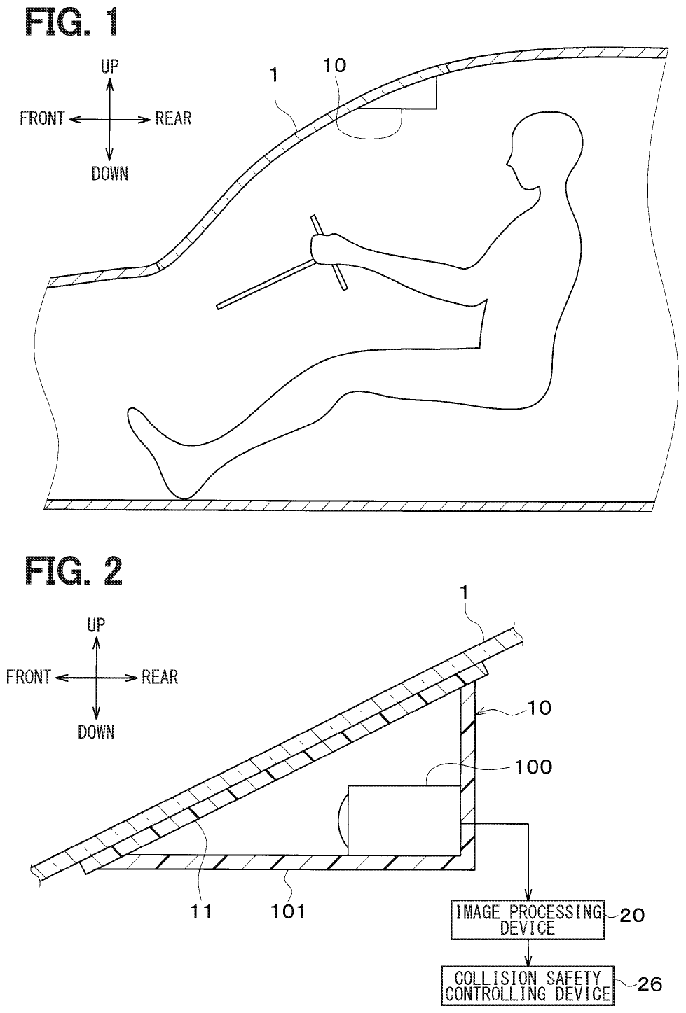

As shown in FIG. 1, the camera unit 10 is mounted on an inner surface of a windshield 1 of the vehicle. The inner surface is a surface of the windshield 1 that is located in a cabin of the vehicle. The camera unit 10 is located at an upper part and an approximately center part of the windshield 1 of the vehicle in a right-left direction. The camera unit 10 is located adjacent to a rear-view mirror (not shown).

As shown in FIG. 2, the camera unit 10 includes the camera 100 and a casing 101. The camera 100 captures a front scene outside the vehicle through a window of the vehicle (in this embodiment, the windshield 1). The camera 100 is an electromagnetic wave apparatus to capture a visible light that is one type of electromagnetic waves. That is, in this embodiment, the camera 100 performs only receiving a visible light as an electromagnetic wave. The windshield 1 is a passage member through which visible lights pass and are captured by the camera 100.

Image data that the camera 100 captures is inputted to an image processing device 20. The image processing device 20 processes image data from the camera 100 and detects an object located in front of the vehicle. A detection result by the image processing device 20 is outputted to a collision safety controlling device 26. The collision safety controlling device 26 prevents collisions by the vehicle by controlling braking of the vehicle based on the detection result by the image processing device 20.

The camera 100 is housed in the casing 101. The casing 101 is a component constituting an outer frame of the camera unit 10. The casing 101 may be in contact with the windshield 1, or may be spaced away from the windshield 1 by a given distance.

The windshield 1 includes a heater 11. The heater 11 removes a fog of the inner surface of the windshield 1 and melts snows and frosts on an outer surface of the windshield 1 by generating a heat and heating the windshield 1.

The heater 11 is transparent with a film shape. The heater 11 is affixed to the inner surface of the windshield 1. The heater 11 may be disposed inside of the windshield 1.

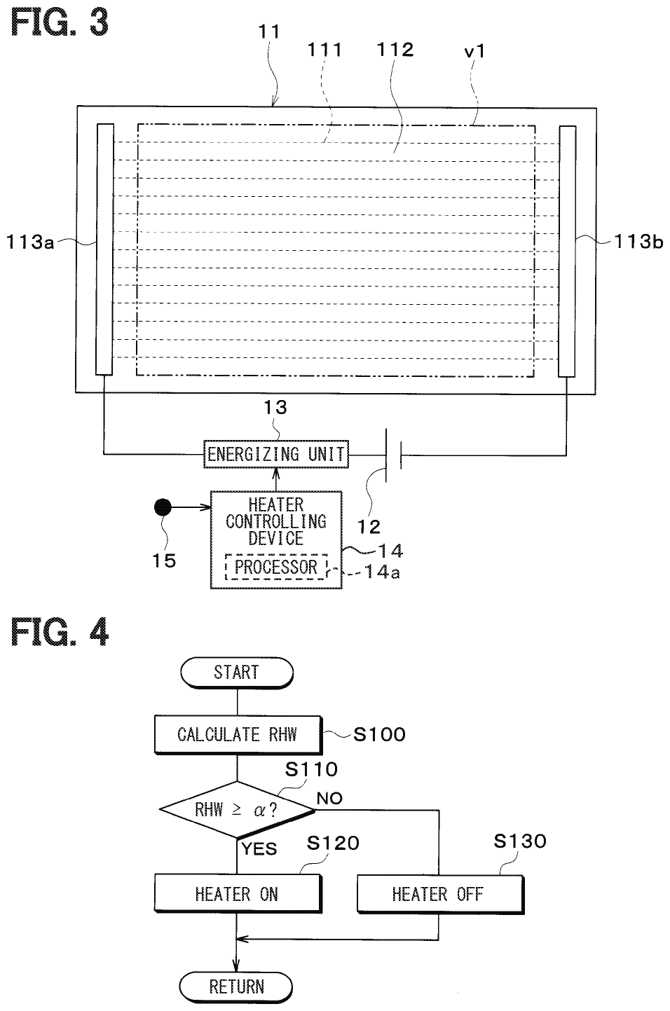

As shown in FIG. 3, the heater 11 includes carbon nanotubes 111 and binders 112. Each of the carbon nanotubes 111 is a heating element that generates a heat when energized. In FIG. 3, the carbon nanotubes 111 are shown by dashed lines.

The carbon nanotube 111, which is also referred to CNT, is a crystal of carbon that has a hollow cylindrical structure. The carbon nanotube 111 has a diameter within a range between 0.7 and 70 nm, which is one tens-thousandth of a diameter of a hair. The carbon nanotube 111 has a tube shape and the length of the carbon nanotube 111 is less than several tens pm.

Each of the binder 112 is a holder that holds the carbon nanotubes 111. The binder 112 is made of transparent resin.

For example, the heater 11 is a thin film in which the carbon nanotubes 111 are dispersed in the binders 112. The heater 11 may have plural liner heating wires made of the carbon nanotubes 111. A diameter of the wire made of the carbon nanotube 111 is approximately two or three pm.

The carbon nanotube 111 is a thin element, so that the carbon nanotube 111 cannot be recognized by bear eyes. The wire made of the carbon nanotube 111 is not recognized by bear eyes, neither. Thus, the heater 11 is recognized as transparent by bear eyes. The carbon nanotube 111 absorbs lights and prevents lights from scattering.

The heater 11 has a pair of electrodes 113a and 113b. The electrodes 113a and 113b are connected to the carbon nanotubes 111.

A direct current is applied to the electrodes 113a and 113b by a battery 12 in the vehicle and the electrodes 113a and 113b energize the carbon nanotubes 111, and then the carbon nanotubes 111 generate a heat. The electrodes 113a and 113b have an elongated, thin shape and are located to extend along both ends of the heater 11.

An energizing unit 13 selectively allows a direct current to apply and prevents a direct current from applying to the electrodes 113a and 113b from the battery 12. The energizing unit 13 has a relay or a switch. The energizing unit 13 is controlled by a heater controlling device 14.

The heater 11 is located at the windshield 1 so that the heater 11 entirely overlaps with a field of view v1 of the camera 100. In FIG. 3, the field of view v1 is indicated by the two-dot chain line only for description purpose. The heater 11 is disposed to cover the entire field of view v1 of the camera 100.

The electrodes 113a and 113b of the heater 11 are located outside of the field of view v1 of the camera 100. Thus, the field of view v1 is not interfered by the heater 11.

The heater controlling device 14 includes a processor 14a, a read only memory (ROM), and a random access memory (RAM) with peripheral circuits. The heater controlling device 14 controls devices connected to the heater controlling device 14 by performing processing in accordance with control programs stored in the ROM.

A window surface humidity sensor 15 is connected to an input side of the heater controlling device 14. The window surface humidity sensor 15 includes a window surroundings humidity sensor, a window surroundings temperature sensor, and a window surface temperature sensor.

The window surroundings humidity sensor detects a relative humidity of an air in a vehicle cabin near the windshield 1. The relative humidity is hereinafter referred to as a “window surroundings relative humidity”. The window surroundings temperature sensor detects a temperature of an air near the windshield 1 in the vehicle cabin. The window surface temperature sensor detects a temperature of a surface of the windshield 1.

The energizing unit 13, the heater controlling device 14, and the window surface humidity sensor 15 constitutes a heater controlling unit configured to control the heater 11.

The heater controlling device 14 performs a control process shown in a flow chart in FIG. 4. The flow chart in FIG. 4 is a subroutine of a control program that the heater controlling device 14 performs.

At step S100, a relative humidity RHW of the inner surface of the windshield 1 is calculated based on a detection value by the window surface humidity sensor 15. The relative humidity RHW is hereinafter referred to as a “window surface relative humidity RHW”.

The window surface relative humidity RHW is an index to indicate a possibility that the windshield 1 fogs up. More specifically, the greater the window surface relative humidity RHW is, the higher the possibility that the windshield 1 fogs up is.

At step S110, the processor 14a determines whether the window surface relative humidity RHW is higher than a threshold α. When the processor 14a determines that the window surface relative humidity RHW is higher than the threshold α, the process proceeds to step S120 and the heater 11 is heated. More specifically, the heater controlling device 14 applies a direct current to the electrodes 113a and 113b of the heater 11 from the battery 12 in the vehicle.

When the windshield 1 is likely to fog up, the heater 11 removes the fog of the windshield 1 by heating the windshield 1. When the windshield 1 fogs up, the heater 11 can remove the fog of the windshield 1 by heating the windshield 1.

On the other hand, when the processor 14a determines that the window surface relative humidity RHW is lower than the threshold a at step S110, the process proceeds to step S130 and the heater 11 is controlled to stop heating. More specifically, the heater controlling device 14 prevents the direct current from applying to the electrodes 113a and 113b of the heater 11.

In this embodiment, the heater 11 to heat the windshield 1 is located at an area of the windshield 1 that is within the field of view v1 of the camera 100. The heater 11 includes the carbon nanotubes 111 and the binders 112. The carbon nanotubes 111 cannot be recognized by bear eyes. The binders 11 are made of transparent material.

The heater 11 is located within the field of view v1 of the camera 100, thus an unclearness of the field of view v1 can be well removed. The carbon nanotubes 111 of the heater 11 are not recognized by bear eyes and the binders 112 of the heater 11 are made of transparent material, thus the heater 11 can be transparent. Hence, the heater 11 does not interfere with the field of view v1 of the camera 100.

In this embodiment, the heating element of the heater 11 is made of the carbon nanotubes 111. The carbon nanotubes 111 can absorb lights and prevent lights from scattering, thus a transparency of the heater 11 can be improved.

In this embodiment, the heater controlling device 14 including the processor 14a determines whether the windshield 1 is likely to fog up based on the detection value by the window surface humidity sensor 15, and energize the heater 11 by controlling the energizing unit 13 upon determining that the windshield 1 is likely to fog up. This results in obtaining an efficient performance of the heater 11.

The energizing unit 13, the heater controlling device 14, and the window surface humidity sensor 15 may determine whether the windshield 1 fogs up or not, and energize the heater 11 upon determining that the windshield 1 fogs up. This allows an efficient performance of the heater 11 as well.

In this embodiment, the electrodes 113a and 114b of the heater 11 are components that can be recognized by bear eyes, but located outside of the field of view v1. Thus, even though the electrodes 113a and 113b can be recognized by bear eyes, the electrodes 113a and 113b do not interfere with the field of view v1 of the camera 100.

### Second Embodiment

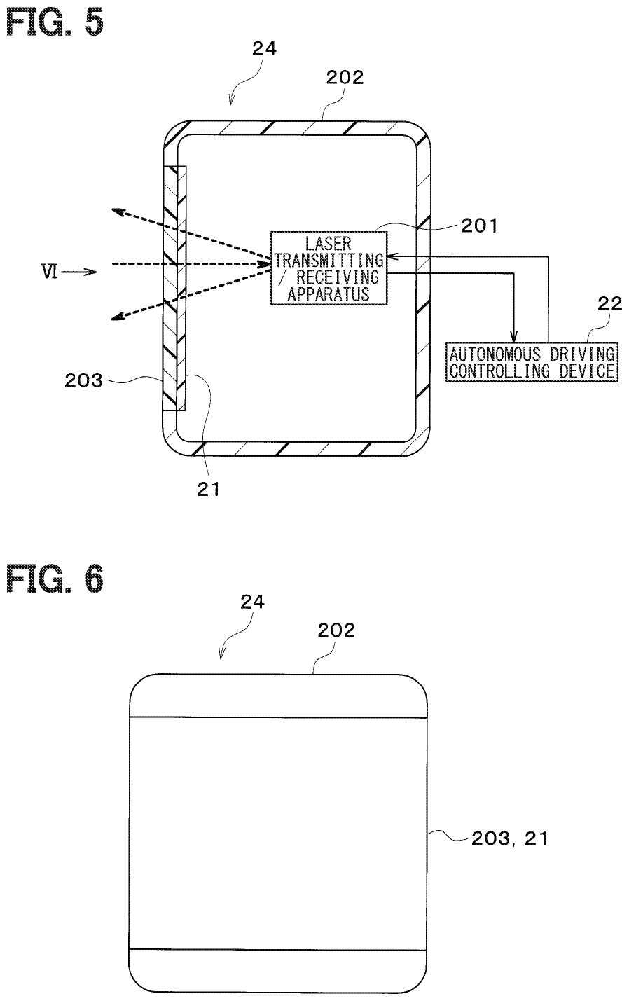

In the above-mentioned embodiment, the image capturing system for a vehicle including the heater 11 was explained. The image capturing system is configured to perform only receiving an electromagnetic wave (i.e., a visible light). In the second embodiment, a laser system 24 for a vehicle including a heater 21 is explained with reference to FIGS. 5 and 6.

The laser system 24 for a vehicle is a system that transmits a laser in a pulse form and measures distances to, directions to, and/or characteristics of objects from time period for the laser to be reflected by the object and return back to the laser system 24 after transmitted. The laser system 24 may be used for a sensor for an autonomous driving of a vehicle.

The laser system 24 includes a laser transmitting/receiving apparatus 201, a casing 202, and a cover 203. The laser transmitting/receiving apparatus 201 detects an object and measures a distance to the object by transmitting a laser and receiving the laser reflected by the object. That is, the laser transmitting/receiving apparatus 201 is an electromagnetic wave apparatus that is configured to perform both transmitting and receiving of an electromagnetic wave. For example, the laser system 24 is disposed at a bumper of the vehicle (not shown) and transmits a laser toward the front side of the vehicle and receives the laser returned to the vehicle. The laser that the laser system 24 transmits is for example a laser having a near infrared wavelength.

The laser transmitting/receiving apparatus 201 is controlled by an autonomous driving controlling device 22. The detection result and the measurement result by the laser transmitting/receiving apparatus 201 are inputted to the autonomous driving controlling device 22. The autonomous driving controlling device 22 performs autonomous driving for the vehicle based on the detection results and the measurement results by the laser transmitting/receiving apparatus 201.

The laser transmitting/receiving apparatus 201 is housed in a space sealed by the casing 202 and the cover 203. The casing 202 and the cover 203 are members to protect the laser transmitting/receiving apparatus 201 in addition to house the laser transmitting/receiving apparatus 201. The casing 202 is located outside of an area through which a laser used by the laser transmitting/receiving apparatus 201 passes. The cover 203 is located within the area through which a laser used by the laser transmitting/receiving apparatus 201 passes. The cover 203 is made of resin.

The heater 21 is a transparent film as with the heater 11 in the first embodiment. The heater 21 includes carbon nanotubes and binders. The carbon nanotubes and the binders of the heater 21 allow a laser used by the laser transmitting/receiving apparatus 201 to transmit therethrough.

A transparency of the heater 21 with respect to a laser used by the laser transmitting/receiving apparatus 201 is equal to or greater than 80%. Thus, the cover 203 does not interfere with traveling of the laser. It is preferable that the transparency of the heater 21 with respect to a laser used by the laser transmitting/receiving apparatus 201 is about 95%.

The heater 21 is affixed to an inner surface of the cover 203 with adhesive. The heater 21 may be affixed to an outer surface of the cover 203. The heater 21 may be formed in the cover 203 by insert-molding.

The heater 21 has flexibility so that the heater 21 can follow a curved surface of the cover 203. The heater 21 is disposed to cover a part of or the entire of the area of the cover 203 through which a laser used by the laser transmitting/receiving apparatus 201 passes.

The cover 203 and the heater 21 are transparent with respect to a laser used by the laser transmitting/receiving apparatus 201. In other words, the cover 203 and the heater 21 allow a laser used by the laser transmitting/ receiving apparatus 201 to transmit therethrough.

A battery in a vehicle (not shown) applies a direct current with electrodes (not shown) of the heater 21, and the carbon nanotubes (not shown) of the heater 21 are energized, which enables the carbon nanotubes to generate a heat. The electrodes of the heater 21 are formed to have an elongated shape extending along both ends of the heater 21.

The casing 202 and the cover 203 define a sealed space, thus the inner surface of the cover 203 may fog up by temperature difference between the inside and the outside of the sealed space. During winter, the outer surface of the cover 203 may be covered with snow.

In this embodiment, the heater 21 can remove a fog on the inner surface of the cover 23 and melt snows on the outer surface of the cover 203 by heating the cover 203.

The heater 21 is transparent with respect to the laser used by the laser transmitting/receiving apparatus 201, thus the heater 21 does not interfere with travelling of the laser through the cover 203.

The cover 203 is made of resin, so that the laser can be less likely absorbed at the cover 203 as compared to a cover made of glass.

### Other Embodiments

The above-mentioned embodiments may be combined appropriately. The above-mentioned embodiments may be modified described later.

In the first embodiment, the camera 100 is configured to only receive an electromagnetic wave (i.e., a visible light), and in the second embodiment, the laser transmitting/receiving apparatus 201 is configured to both transmit and receive an electromagnetic wave (i.e., a laser). However, an electromagnetic wave apparatus may perform only transmitting of an electromagnetic wave. That is, an electromagnetic wave apparatus may be configured to i) transmit an electromagnetic wave only, ii) receive an electromagnetic wave only, or iii) transmit and receive an electromagnetic wave.

In the first embodiment, the heater 11 is located at the windshield 1 and disposed to cover the entire field of view v1 of the camera 100. The heater 11 may be disposed to cover I the entire windshield 1. This enables removing a fog of the windshield 1 well. The heater 11 is transparent thus the heater 11 does not interfere with a field of view of an occupant in a vehicle.

In the first embodiment, the camera unit 10 and the heater 11 are disposed at the windshield 1, but the camera unit 10 and the heater 11 may be disposed at other windows than the windshield 1 such as a rear window.

In the first embodiment, the heater 11 is located at the windshield 1, but the heater 11 may be located at a cover to protect a lighting device, that is a device transmitting a visible light, such as a head light cover for a vehicle. The cover of the lighting device is made of glass or resin.

In the first embodiment, the carbon nanotubes 111 are utilized as the heating element of the heater 11, but the heating element of the heater 11 may be a member that cannot be recognized by bear eyes such as metal particles, carbon particles, and metal oxide particles. The heating element of the heater 11 should be a member that is transparent with respect to the light used by the camera 100.

In the first embodiment, image data of the camera 100 is utilized to prevent collisions by a vehicle, but the usage of the image data is not limited to this. The image data of the camera 100 may be utilized to prevent a vehicle from deviating from a lane or to measure a distance to a vehicle traveling ahead.

The camera 100 in the first embodiment captures a visible light but may capture an infrared light or an ultraviolet light.

The laser system 24 for a vehicle in the second embodiment transmits and receives a laser toward the front side of the vehicle, but may be configured to transmit and receive a laser while the laser transmitting/receiving apparatus 201 rotates on a horizontal plane. In such case, the heater 21 may be configured to rotate together with the laser transmitting/receiving apparatus 201 or to surround the laser transmitting/receiving apparatus 201 360 degrees in a horizontal direction.

In the second embodiment, the heater 21 is used for the laser system 24 for a vehicle, but the heater 21 may be used for an electric wave apparatus for a vehicle. The electric wave apparatus for a vehicle measures distances to, directions to, and/or characteristics of objects from time period for the laser to be reflected by the object and return back to the electric wave apparatus after transmitted. The electric wave apparatus may be used for a sensor for an autonomous driving of a vehicle.

In this case, the heater 21 prevents moisture of a fog from affecting on the electric wave by removing the fog of a cover of the electric wave apparatus for a vehicle.

In the second embodiment, the heating element of the heater 21 is carbon nanotubes, but the heating element of the heater 21 may be indium tine oxide or silver mesh while the heating element of the heater 21 is transparent with respect to a laser used by the laser transmitting/receiving apparatus 201.

In the above-mentioned embodiment, an image capturing system for a vehicle and a laser system for a vehicle are explained as concrete examples for an electromagnetic wave utilizing system, but the electromagnetic wave utilizing system may be a stationary image capturing system or a stationary laser system.

1. An electromagnetic wave utilizing system, comprising:
an electromagnetic wave apparatus configured to perform at least one of transmitting and receiving of an electromagnetic wave; and
a heater that heats a passage member through which the electromagnetic wave passes, wherein
the heater includes:
a heating element that generates a heat when energized; and
a holder that holds the heating element,
the heating element and the holder are transparent to allow the electromagnetic wave to transmit therethrough,
the electromagnetic wave apparatus transmits and/or receives the electromagnetic wave while rotating on a horizontal plane, and
the heater is configured to rotate together with the electromagnetic wave apparatus or to surround the electromagnetic wave apparatus 360 degrees in a horizontal direction.

2. The electromagnetic wave utilizing system according to claim 1, wherein
the heating element is made of carbon nanotube.

3. The electromagnetic wave utilizing system according to claim 2, wherein
the passage member is made of resin.

4. The electromagnetic wave utilizing system according to claim 1, wherein
the electromagnetic wave apparatus is configured to:
transmit a laser as the electromagnetic wave; and
receive the laser that is reflected by an object, and
the passage member is a cover that protects the electromagnetic wave apparatus.

5. The electromagnetic wave utilizing system according to claim 1, wherein
the passage member is a window,
the electromagnetic wave apparatus is a camera that captures a scene outside a vehicle through the window, and
the heater is located at an area of the window that is within a field of view of the camera.

6. The electromagnetic wave utilizing system according to claim 5, further comprising:
a heater controlling unit configured to:
determine whether the window is likely to fog up; and
energize the heater upon determining that the window is likely to fog up.

7. The electromagnetic wave utilizing system according to claim 5, further comprising:
a heater controlling unit configured to:
determine whether the window fogs up; and
energize the heater upon determining that the window fogs up.

8. The electromagnetic wave utilizing system according to claim 5, wherein
the heater has a pair of electrodes electrically connected to the heating element, and
the electrodes are located outside of the field of view.

9. The electromagnetic wave utilizing system according to claim 1, wherein
the electromagnetic wave apparatus is configured to transmit a visible light as the electromagnetic wave, and
the passage member is a cover that protects the electromagnetic wave apparatus.

10. The electromagnetic wave utilizing system according to claim 5, further comprising:
a processor programmed to:
determine whether the window is likely to fog up; and
energize the heater upon determining that the window is likely to fog up.

11. The electromagnetic wave utilizing system according to claim 10, further comprising:
a window surface humidity sensor configured to detect:
a relative humidity of an air in a vehicle cabin at a position near the window;
a temperature of an air in the vehicle cabin at a position near the window; and
a temperature of a surface of the window, wherein
the processor is further programmed to:
calculate a window surface relative humidity based on the relative humidity, the temperature of the air, and the temperature of the surface of the window detected by the window surface humidity sensor;
determine whether the window surface relative humidity is equal to or greater than a threshold; and
determine that the window is likely to fog up upon determining that the window surface relative humidity is equal to or greater than the threshold.

12. The electromagnetic wave utilizing system according to claim 5, further comprising:
a processor programmed to:
determine whether the window fogs up; and
energize the heater upon determining that the window fogs up.

13. The electromagnetic wave utilizing system according to claim 12, further comprising:
a window surface humidity sensor configured to detect:
a relative humidity of an air in a vehicle cabin at a position near the window;
a temperature of an air in the vehicle cabin at a position near the window; and
a temperature of a surface of the window, wherein
the processor is further programmed to determine whether the window fogs up based on the relative humidity, the temperature of the air, and the temperature of the surface of the window detected by the window surface humidity sensor.
